(19) United States
(12) Patent Application Publication
(10) Pub. No.: US 2026/0160952 A1
(43) Pub. Date: Jun. 11, 2026

(54) LOW LOSS FAN-IN FAN-OUT (FIFO) DEVICES

(71) Applicant: II-VI Photonics, Inc., Fujian Province (CN)

(72) Inventors: Yunbing Xu, Fuzhou (CN); Tingyu Xue, Fuzhou (CN); Baozhong Zheng, Fuzhou (CN); Wuli Zhao, Fuzhou (CN); Zongyuan Wang, Fuzhou (CN); Niannian Lin, Fuzhou (CN); Yang Li, Fuzhou (CN)

(21) Appl. No.: 18/984,311

(22) Filed: Dec. 17, 2024

(30) Foreign Application Priority Data
Dec. 11, 2024 (CN) 2024118226985

(51) Int. Cl. G02B 6/34

(52) U.S. Cl. CPC G02B 6/34

(57) ABSTRACT

A fan-in-fan-out (FIFO) optical device may include a multiple-core fiber (MCF) collimator including a plurality of fiber cores; a plurality of single-mode fiber (SMF) collimators, where each SMF collimator includes a single fiber core; and a device body engaging the MCF collimator and the plurality of SMF collimators. The device body may define an interior space. The MCF collimator and the plurality of SMF collimators may be arranged and/or configured to communicate within the interior space, a plurality of collimated beams. Each collimated beam may be communicated between one of the plurality of SMF collimators and a corresponding one of the plurality of cores in the MCF collimator.

### CLAIM OF PRIORITY

This patent application claims priority to and claims benefit from Chinese (CN) Patent Application Serial No. 2024118226985, filed on Dec. 11, 2024. The above identified application is hereby incorporated herein by reference in its entirety.

### TECHNICAL FIELD

Aspects of the present disclosure relate to optical communication based solutions. More specifically, certain implementations of the present disclosure relate to methods and systems for low loss fan-in fan-out (FIFO) devices.

### BACKGROUND

Limitations and disadvantages of conventional and traditional devices and solutions for transmitting and receiving optical signals will become apparent to one of skill in the art, through comparison of such systems with some aspects of the present disclosure as set forth in the remainder of the present application with reference to the drawings.

### BRIEF SUMMARY

System and methods are provided for low loss fan-in fan-out (FIFO) devices, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 illustrates different example conventional designs of fan-in-fan-out (FIFO) optical devices.

FIG. 2 illustrates an example low loss 2-core multi-core fiber fan-in-fan-out optical device, in accordance with the present disclosure.

FIG. 3 illustrates an example low loss 4-core multi-core fiber fan-in-fan-out optical device, in accordance with the present disclosure.

FIG. 4 illustrates an example low loss multi-core fiber fan-in-fan-out optical device with integrated isolator, in accordance with the present disclosure.

FIG. 5 illustrates an example low loss 2-core multi-core fiber fan-in-fan-out optical device with beam spacing, in accordance with the present disclosure.

FIG. 6 illustrates an example low loss 4-core multi-core fiber fan-in-fan-out optical device with beam spacing, in accordance with the present disclosure.

FIG. 7 illustrates an example collimator.

### DETAILED DESCRIPTION

The present disclosure is directed to optical communication related solutions. In particular, embodiments based on the present disclosure pertain to optical connectors, and specifically to improved fan-in-fan-out (FIFO) optical devices that may be used in fiber-optic communication. In this regard, various types of fibers may be used in optical communication networks. One common type is single-mode fiber (SMF), which is an optical fiber comprising a single core configured to carry (propagate) a single light beam, typically of a single mode of light (e.g., transverse mode). To increase capacity, in some optical communication networks, other types of fiber allowing for multiple concurrent optical transmissions may be used. For example, multi-core fiber (MCF) may be used. The MCF comprises multiple cores, with each core typically configured to carry (propagate) a single light beam. In some instances, the MCF may be the same size as SMF, and as such the multiple cores of MCF may be arranged within the same space/size used in SMF. As such, use of MCF may allow for multiplication of transmission capacity without increasing space requirements.

In some instances, there may be a need to provide a connection between a multi-core fiber (MCF) based system and a single-core optical (SMF) based system (e.g., when going from MCF-based optical communication networks to SMF-based optical communication networks, or vice versa). To facilitate such connections, suitable systems or devices that allow for transition between MCF and SMF may be used. One example of such systems or devices is fan-in-fan-out (FIFO) optical devices, which may be used in facilitating such transitions. Such FIFO optical devices may incorporate some design or mechanism for enabling SMF-MCF connections, such as by enabling coupling a SMF to each of the multiple cores within the MCF.

However, conventional designs that may be used in FIFO optical devices have some limitations and/or shortcomings. In particular, coupling mechanisms used in many conventional designs may lead to performance degradation, such as high insertion losses. Solutions based on the present disclosure provide FIFO optical devices that overcome at least some limitations and/or shortcomings of conventional designs, particularly incorporating improved coupling designs that yield enhanced performance by eliminating or at least reducing some of the performance degradation associated with conventional designs.

Example embodiments in accordance with the present disclosure are described in more detail below, particularly with respect to the figures.

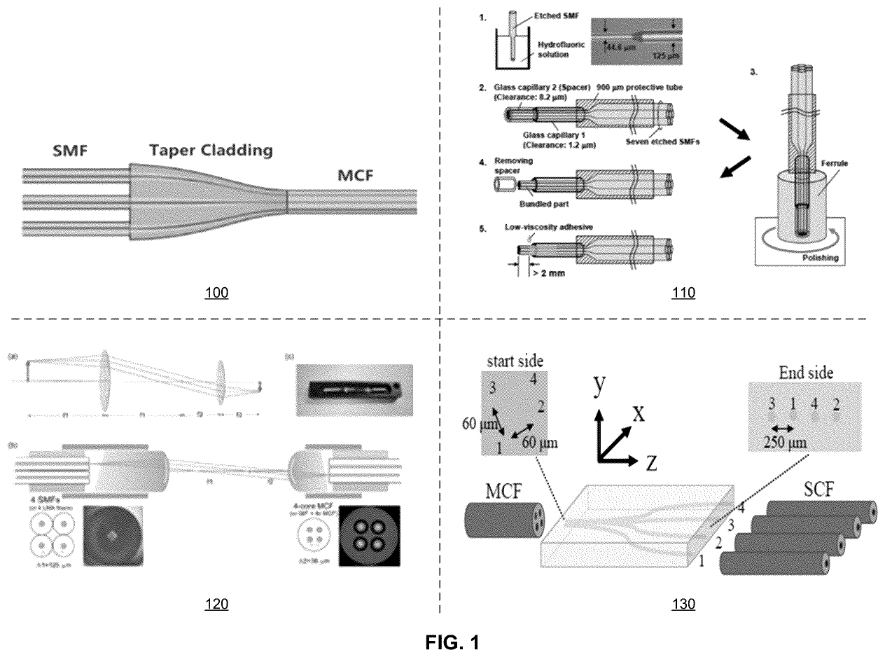

FIG. 1 illustrates different example conventional designs of fan-in-fan-out (FIFO) optical devices. Shown in FIG. 1 are FIFO optical devices 100, 110, 120, and 130.

As illustrated in FIG. 1, the FIFO optical device 100 incorporates a fusion taper based design, the FIFO optical device 110 incorporates an etched fibers based design, the FIFO optical device 120 incorporates a thermal expansion core (TEC) fibers based design, and the FIFO optical device 130 incorporates a waveguide chip based design.

In this regard, the designs used in and illustrated by the FIFO optical devices 100, 110, 120, and 130 represent examples of conventional designs. However, as noted above, conventional designs used in implementing FIFO optical devices may have some limitations and shortcomings. In particular, various implementation methods used in FIFO optical devices, including those used in the FIFO optical devices 100, 110, 120, and 130, may have such performance issues as higher insertion losses.

In this regard, FIFO optical devices incorporating conventional designs, whether based on fusion taper, etched fibers, thermal expansion core (TEC) fibers, or waveguide chips, all suffer from high insertion losses, because the insertion loss of every channel may not be independently finely optimized. For example, the insertion loss in such conventional designs typically may be in 0.3-2.0 dB range. Reducing or eliminating such insertion loss would result in improved performance.

Solutions based on the present disclosure address at least some of the issues associated with such conventional designs. In particular, embodiments based on the present disclosure incorporate new fan-in-fan-out designs/structures that are particularly configured to eliminate or at least reduce such high insertion losses. For example, this may be done by use of suitable components for engaging the SMF and MCF on opposite ends of the FIFO optical device, with these components providing a mechanism for communicating the signals between the MCF and SMF within the FIFO optical device without requiring etching or other mechanisms or features required in conventional design. These components may be adaptively selected and/or configured to optimize alignment, such as by being independently adjustable, thus allowing for improvement of performance (e.g., obtaining a lowest insertion loss possible).

For example, in various embodiments, collimators may be used for terminating the MCF and SMF connecting into the FIFO optical device, with these collimators being arranged to allow for transmission of light beams within the FIFO optical device to facilitate the required MCF-SMF connectivity. The proposed designs may also incorporate additional components for further optimizing performance, such as with respect to communication of light beams within the FIFO optical devices.

In various embodiments, since every output single fiber collimator may be tuned independently, and as such the insertion loss may be optimized to a considerably low value compared to conventional designs (e.g., insertion loss value may be 0 to 0.3 dB).

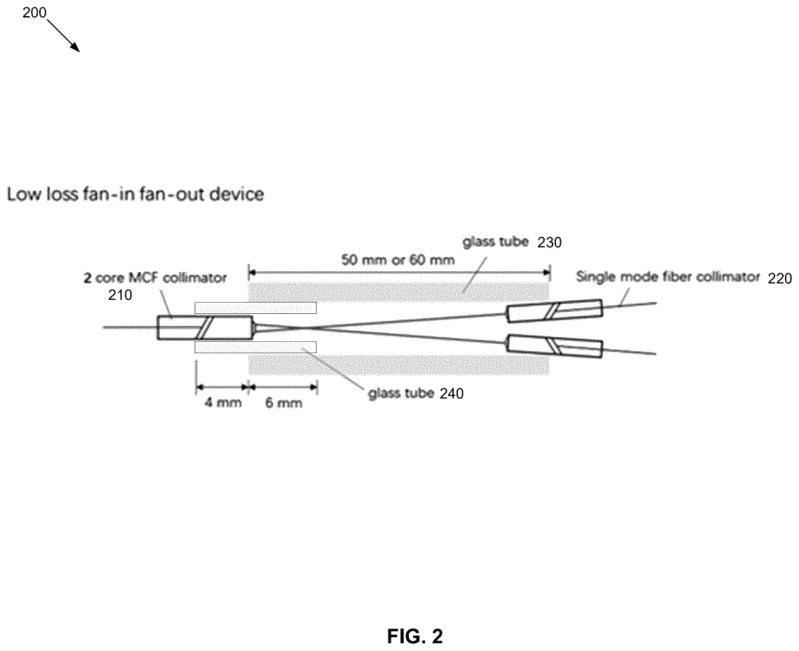

Example embodiments incorporating various aspects of such designs are illustrated and described with respect to FIGS. 2-6.

FIG. 2 illustrates an example low loss 2-core multi-core fiber fan-in-fan-out optical device, in accordance with the present disclosure. Shown in FIG. 2 is a multi-core fiber (MCF) fan-in-fan-out (FIFO) optical device 200.

As shown in FIG. 2, the MCF FIFO optical device 200 comprises a two core (2-core) multi-core fiber (MCF) collimator 210, two single mode fiber (SMF) collimators 220, an external glass tube 230, and inner glass tube 240.

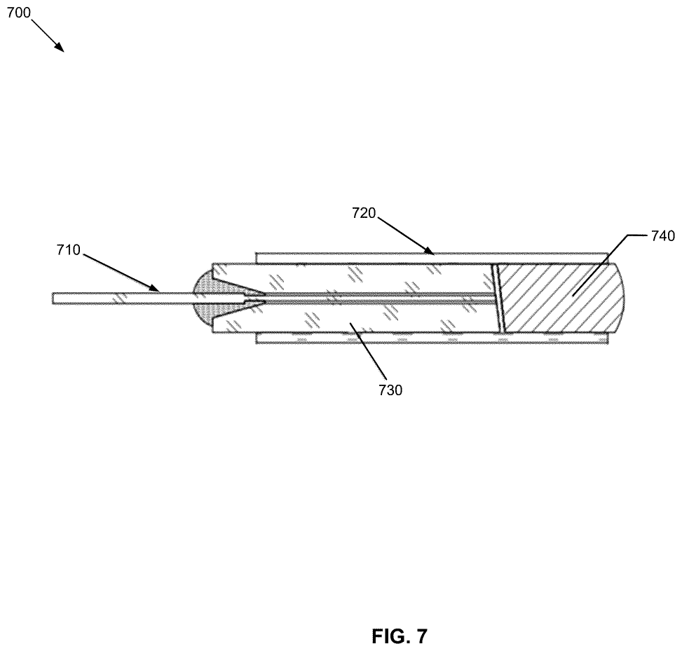

The 2-core MCF collimator 210 comprises a collimator configured for engaging and/or coupling to a 2-core MCF. Each SMF collimator 220 comprises a collimator configured for engaging and/or coupling to a SMF. In this regard, a collimator is a device configured to couple an optical fiber and free-space, such as by transforming light output from the optical fiber into a free-space collimated beam, and/or transforming a free-space collimated beam into light input into the optical fiber. An example collimator is illustrated and described with respect to FIG. 7.

The 2-core MCF collimator is 210 held by the inner glass tube 240, which in turn is held by the external glass tube 230, at one end thereof. The two SMF collimators 220 are attached at the other end of the external glass tube 230. In this regard, the SMF collimators 220 are arranged at a particular angle, which is set to match the angle of the corresponding collimated beams from the MCF collimator 210, as shown in FIG. 2. Further, as illustrated the SMF collimators 220 may be inverted relative to the corresponding collimated beam(s). The inversion is to account for use of lenses (in opposite positions) in the MCF collimator and the SMF collimators. The SMF collimators 220 may be independently adjusted, such as to optimize alignment, thus allowing for obtaining a lowest insertion loss as possible, resulting in a low loss fan-in-fan-out component.

The external glass tube 230 and the inner glass tube 240 may have a suitable shape (e.g., circular cross-section). Further, as suggested by their name, the external glass tube 230 and the inner glass tube 240 may comprise suitable glass material for facilitating operation of the MCF FIFO optical device 200—e.g., having suitable optical characteristics (e.g., opacity, etc.). Nonetheless, the disclosure is not limited to use of glass tubes, and any suitable material may be used if meeting performance requirements.

The dimensions of the external glass tube 230 and the inner glass tube 240 may be adaptively set, that is, for example, to accommodate the other components in the FIFO optical device, applicable size requirements, preferences, etc. For example, as shown in FIG. 2, the external glass tube 230 has a length of 50 or 60 mm. The inner glass tube 240 has a length of 10 mm, with a portion thereof (e.g., 6 mm) inserted within the external glass tube 230. Nonetheless, it should be understood that the dimensions provided herein (and with respect to the other figures) are by way of example only, and that the disclosure is not limited to such dimensions. In some instances, a suitable adhesive or bonding material may be used to secure the inner glass tube 240 to the external glass tube 230.

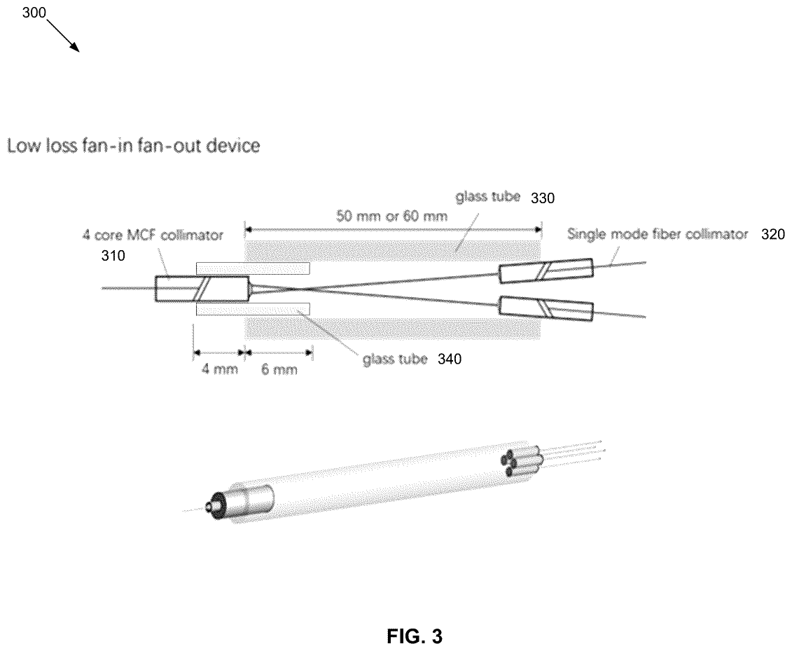

While the MCF FIFO optical device 200 is a 2-core based implementation, the disclosure is not so limited, and other implementations may have more cores. In this regard, the number of cores (in the MCF) that may be supported in the proposed FIFO optical devices is limited only by number of SMF collimators that may be accommodated at the one side of the device—that is, physical (space) limited. An example 4-core based embodiment is illustrated and described in more detail with respect to FIG. 3.

FIG. 3 illustrates an example low loss 4-core multi-core fiber fan-in-fan-out optical device, in accordance with the present disclosure. Shown in FIG. 3 is multi-core fiber (MCF) fan-in-fan-out (FIFO) optical device 300.

As shown in FIG. 3, the MCF FIFO optical device 300 comprises a four core (4-core) multi-core fiber (MCF) collimator 310, four single mode fiber (SMF) collimators 320, an external glass tube 330, and an inner glass tube 340. In this regard, each of these components may be substantially similar to the similarly named components of the MCF FIFO optical device 200, and may operate in a substantially similar manner. However, the 4-core MCF collimator 310 comprises 4 cores (rather than 2 cores as it is the case in the 2-core MCF collimator 210), and as such may provide output of 4 (rather than 2) collimated beams, which in turn may involve use of 4 (rather than 2) SMF collimators.

The 4-core MCF collimator 310 is held by the inner glass tube 340, which in turn is held by the external glass tube 330, at one end thereof. The four SMF collimators 320 are attached at the other end of the external glass tube 330. The external glass tube 330 and the inner glass tube 340 may have similar dimensions (e.g., with the external glass tube 330 have a length of 50 or 60 mm, and the inner glass tube 340 having a length of 10 mm, with a recess of 6 mm within the external glass tube 330), and may be arranged in a similar manner.

The SMF collimators 320 are arranged at a particular angle, which is set to match the angle of the corresponding collimated beams from the MCF collimator 310, as shown in FIG. 3, particularly in the bottom illustration which shows the arrangement and positioning of the 4 MCF collimator 310. The SMF collimators 320 are positioned inverted relative to the corresponding collimated beam(s). As noted, this inversion is to account for use of lenses in the MCF collimator and the SMF collimators. The SMF collimators 320 similarly may be independently adjusted, such as to optimize alignment, thus allowing for obtaining a lowest insertion loss as possible, resulting in a low loss fan-in-fan-out component.

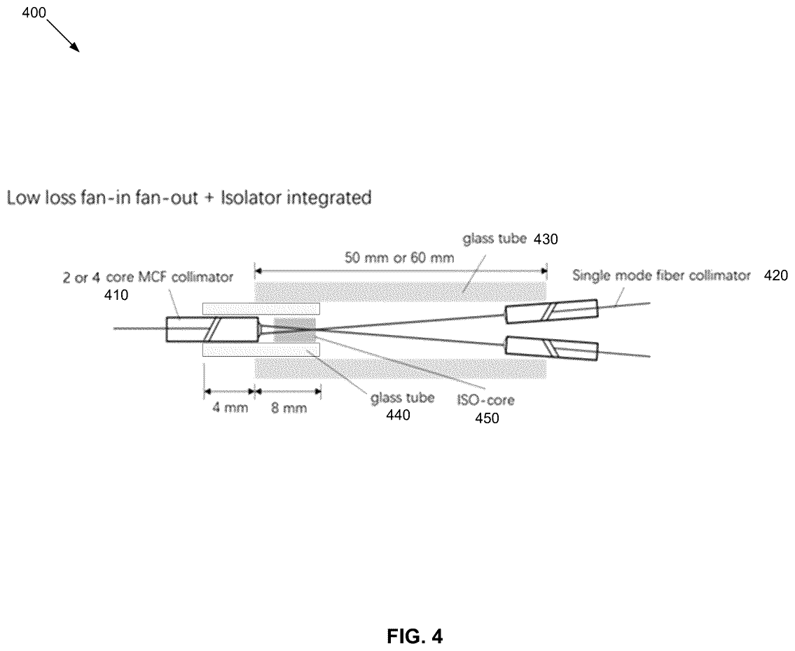

FIG. 4 illustrates an example low loss multi-core fiber fan-in-fan-out optical device with an integrated isolator, in accordance with the present disclosure. Shown in FIG. 4 is multi-core fiber (MCF) fan-in-fan-out (FIFO) optical device 400.

As shown in FIG. 4, the MCF FIFO optical device 400 comprises a multi-core fiber (MCF) collimator 410, a plurality of single mode fiber (SMF) collimators 420, an external glass tube 430, and an inner glass tube 440. In this regard, each of these components may be substantially similar to the similarly named components of the MCF FIFO optical device 200 and/or the MCF FIFO optical device 300, and may operate in a substantially similar manner. As shown in FIG. 4, the MCF collimator 410 may either be a 2-core MCF collimator (thus similar to the 2-core MCF collimator 210) or a 4-core MCF collimator (thus similar to the 4-core MCF collimator 310). As such, either 2 or 4 SMF collimators 420 may be used—matching the number of cores in the MCF collimator 410.

The MCF FIFO optical device 400 further comprises an isolator core 450, thus providing a low loss fan-in-fan-out component with an integrated isolator. In this regard, the isolator core 450 may comprise suitable material that provides optical isolation—that is, allowing propagation of light in one direction while eliminating or at least reducing reflections in the other direction.

As illustrated in FIG. 4, the isolator core 450 is added into the optical path (e.g., close to the MCF collimator 410). For example, the isolator core 450 may be disposed within the inner glass tube 440, just after the MCF collimator 410, as shown. To accommodate the isolator core 450, the length of the inner glass tube 440 (e.g., from 10 mm as described above to 12 mm). As noted, the isolator core 450 provides an isolation function, thus allowing transmission of light beams in one direction (e.g., out of the MCF collimator 410 within the MCF FIFO optical device 400, thus left to right in the figure) but not in the other direction.

The use and inclusion of the isolator core is not dependent on or limited by a number of cores in the MCF used in the FIFO optical device. In this regard, as noted above, the number of cores (in the MCF) that may be supported is limited only by number of SMF collimators that may be accommodated at the one side of the device—that is, physical (space) limited. As such, an integrated isolator core may be used with different number of cores.

For example, with reference to the embodiment shown in FIG. 4, the isolator core 450 is added at the output end of the four-core MCF collimator 410, thus providing isolation on each of the collimated beams being communicated to the corresponding one of four SMF collimators 420. Thus, since every output single fiber collimator may be tuned independently, the insertion loss may be optimized to a considerable low value compared to previous schemes.

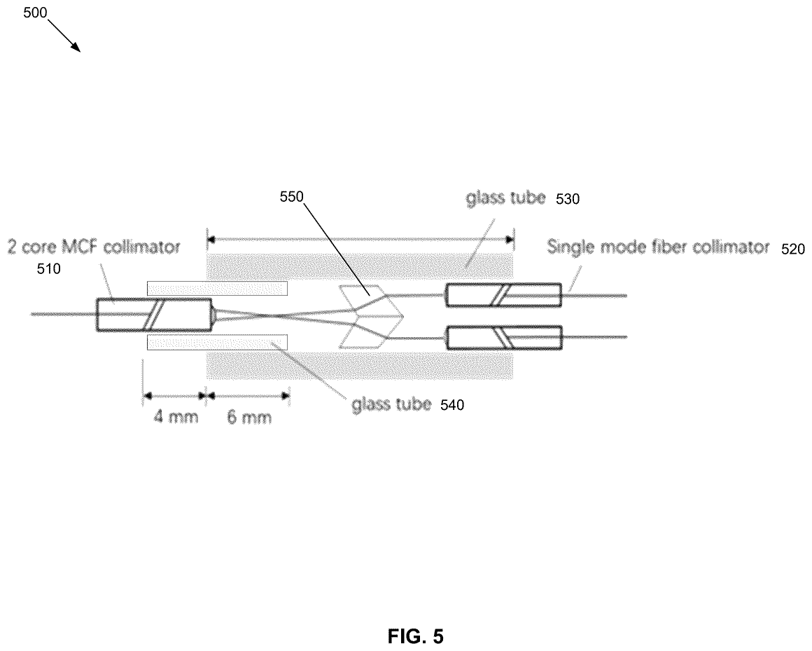

FIG. 5 illustrates an example low loss 2-core multi-core fiber fan-in-fan-out optical device with beam spacing, in accordance with the present disclosure. Shown in FIG. 5 is multi-core fiber (MCF) fan-in-fan-out (FIFO) optical device 500.

As shown in FIG. 5, the MCF FIFO optical device 500 comprises a multi-core fiber (MCF) collimator 510, a plurality of single mode fiber (SMF) collimators 520, an external glass tube 530, and an inner glass tube 540. In this regard, each of these components may be substantially similar to the similarly named components of the MCF FIFO optical device 200 and/or the MCF FIFO optical device 300, and may operate in a substantially similar manner. As shown in FIG. 5, the MCF collimator 510 is 2-core MCF collimator (thus similar to the 2-core MCF collimator 210), and as such, 2 SMF collimators 520 are used—matching the number of cores in the MCF collimator 510.

The MCF FIFO optical device 500 further comprises one or more optical beam control components, which may comprise suitable material and/or may have suitable characteristics (e.g., size, shape) to enable controlling (e.g., manipulating) the collimated beams within the MCF FIFO optical device 500, to further optimize performance. For example, the one or more optical beam control components may be adaptively configured for spacing the collimated beams, to enable shortening the length the FIFO optical device.

In the example embodiment illustrated in FIG. 5, the MCF FIFO optical device 500 comprises a glass wedge prism pair 550, which is added into the optical path, between the MCF collimator 510 and the two SMF collimators 520, to expand the spacing of two beams, thus shortening the overall length of a dual-channel fan-in-fan-out optical device.

In some instances, other optical beam manipulation components may be used. For example, in the MCF FIFO optical device 500, a wedge plate pair (not shown) may be added at the output end of dual-core fiber, to further shorten the length of dual-channel fan-in-fan-out optical device.

Further, in some instances, other components may be added to further enhance performance. For example, an isolation core (similar to the isolation core 450 of FIG. 4) may also be added, which allows for further enhancement of isolation performance in the FIFO optical device.

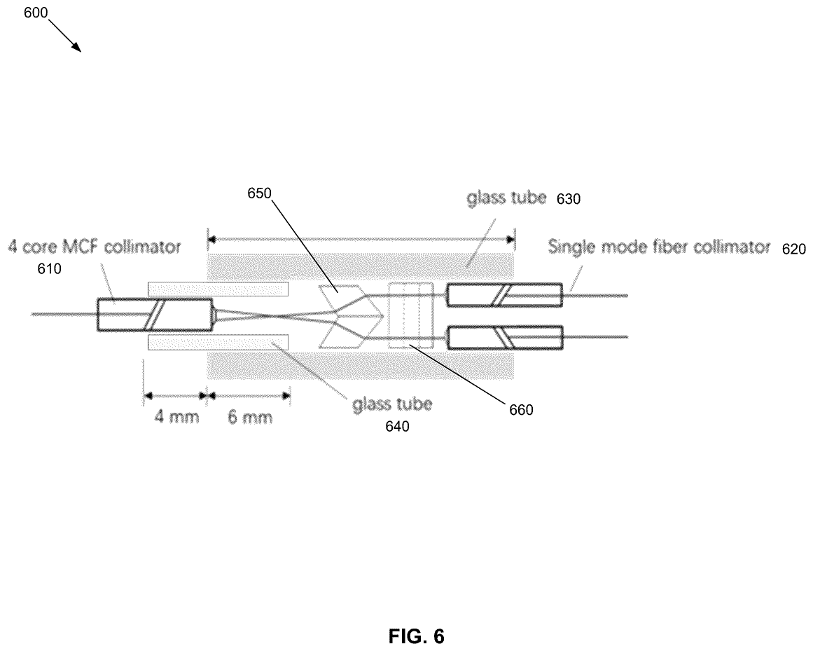

FIG. 6 illustrates an example low loss 4-core multi-core fiber fan-in-fan-out optical device with beam spacing, in accordance with the present disclosure. Shown in FIG. 6 is multi-core fiber (MCF) fan-in-fan-out (FIFO) optical device 600.

As shown in FIG. 6, the MCF FIFO optical device 600 comprises a multi-core fiber (MCF) collimator 610, a plurality of single mode fiber (SMF) collimators 620, an external glass tube 630, and an inner glass tube 640. In this regard, each of these components may be substantially similar to the similarly named components of the MCF FIFO optical device 200 and/or the MCF FIFO optical device 300, and may operate in a substantially similar manner.

The MCF FIFO optical device 600 may be substantially similar to the MCF FIFO optical device 500, and thus may similarly incorporate optical beam control components for enhancing performance as described. For example, as shown in FIG. 6, the MCF FIFO optical device 600 may comprise glass wedge prism(s) 650 and wedge plate(s) 660, for providing beam spacing. However, as illustrated in FIG. 6, the MCF FIFO optical device 600 may be a 4-channel based device rather than 2-channel based device, as is the case with the MCF FIFO optical device 500. As such, the MCF collimator 610 is a 4-core MCF collimator, and there are 4 SMF collimators 620 used in the MCF FIFO optical device 600. Accordingly, the optical beam control components may be modified or adjusted to accommodate the increase in number of channels.

For example, because the MCF FIFO optical device 600 has 4 MCF-SMF connections/channels (that is, a four-channel FIFO optical device), two glass wedge prism pairs 650 may be used (rather than a single pair in the MCF FIFO optical device 500), with these two pairs added into the optical path to shorten the length of the four-channel fan-in-fan-out optical device, as shown in FIG. 6. In this regard, while it may appear that only two glass wedge prisms are used, a further two glass wedge prisms are also used for the two other collimators 620 not shown.

Similarly, two wedge plate pairs 660 may be added (rather than a single pair in the MCF FIFO optical device 500) at the output end of four-core fiber, to shorten the length of four-channel fan-in-fan-out optical device.

Further, similarly in some instances, other components (e.g., an isolation core, similar to the isolation core 450 of FIG. 4) may be added to further enhance performance. In this regard, the addition of the isolation core may allow for further enhancement of isolation performance in the FIFO optical device.

FIG. 7 illustrates an example collimator. Shown in FIG. 7 is a collimator 700. The collimator 700 may comprise a fiber 710, an tube housing 720, a capillary 730, and a lens 740. In this regard, as shown in FIG. 7, the fiber 710 is disposed within the capillary 730 and terminates at the lens 740, with the tube housing 720 enclosing the remaining internal components, as shown.

Depending on the implementation, the collimator 700 may be configured as single-mode fiber (SMF) or a multi-core fiber (MCF) collimator, with the fiber 710 being, correspondingly in such implementations, a single-mode fiber (SMF) or a multi-core fiber (MCF). For example, in instances where the collimator 700 is a MCF collimator, the fiber 710 comprises a multi-core fiber 710, with optical beams emitted from different fiber cores in the fiber 710 transmitted through the lens 740 and exiting in different angles.

An example fan-in-fan-out (FIFO) optical device, based on the present disclosure, comprises a multiple-core fiber (MCF) collimator comprising a plurality of fiber cores; a plurality of single-mode fiber (SMF) collimators, where each SMF collimator comprises a single fiber core; and a device body engaging the MCF collimator and the plurality of SMF collimators; where the device body defines an interior space, where the MCF collimator and the plurality of SMF collimators are arranged and/or configured to communicate within the interior space, a plurality of collimated beams, and where each collimated beam is communicated between one of the plurality of SMF collimators and a corresponding one of the plurality of cores in the MCF collimator.

In an example embodiment, the device body comprises an external optical tube.

In an example embodiment, the device body further comprises an internal optical tube that holds at least a portion of the MCF collimator.

In an example embodiment, at least a portion of the internal optical tube is disposed within the external optical tube.

In an example embodiment, the internal optical tube is securely bonded or attached to the external optical tube.

In an example embodiment, the FIFO optical device further comprises and isolator core configured to apply isolation function to the plurality of collimated beams.

In an example embodiment, the isolator core is disposed at an output end of the MCF collimator.

In an example embodiment, the FIFO optical device further comprises one or more optical beam control components configured for controlling the plurality of collimated beams within the FIFO optical device.

In an example embodiment, the one or more optical beam control components comprise one or more beam spacing components.

In an example embodiment, the one or more beam spacing components comprise one or more glass wedge prisms.

In an example embodiment, the one or more optical beam control components comprise one or more beam shortening components.

In an example embodiment, the one or more beam shortening components comprise glass wedge plates.

In an example embodiment, the MCF collimator is a 2-core MCF collimator, where the plurality of SMF collimators comprises two SMF collimators.

In an example embodiment, the MCF collimator is a 4-core MCF collimator, where the plurality of SMF collimators comprises four SMF collimators.

In an example embodiment, where each of the MCF collimator and the plurality of SMF collimators comprises a fiber, an outer tube, a capillary, and an optical output element.

In an example embodiment, the optical output element comprises a lens.

In an example embodiment, the MCF collimator and the plurality of SMF collimators are arranged and/or configured to meet predefined performance criteria, with the performance criteria comprising at least insertion loss.

In an example embodiment, the MCF collimator and the plurality of SMF collimators are arranged and/or configured to optimize alignment of the plurality of SMF collimators relative to the MCF collimator, to reduce insertion loss.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical implementation may comprise one or more application specific integrated circuit (ASIC), one or more field programmable gate array (FPGA), and/or one or more processor (e.g., x86, x64, ARM, PIC, and/or any other suitable processor architecture) and associated supporting circuitry (e.g., storage, DRAM, FLASH, bus interface circuits, etc.). Each discrete ASIC, FPGA, Processor, or other circuit may be referred to as “chip,” and multiple such circuits may be referred to as a “chipset.” Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to perform processes as described in this disclosure. Another implementation may comprise a non-transitory machine-readable (e.g., computer readable) medium (e.g., FLASH drive, optical disk, magnetic storage disk, or the like) having stored thereon one or more lines of code that, when executed by a machine, cause the machine to be configured (e.g., to load software and/or firmware into its circuits) to operate as a system described in this disclosure.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A fan-in-fan-out (FIFO) optical device comprising:
a multi-core fiber (MCF) collimator comprising a plurality of fiber cores;
a plurality of single-mode fiber (SMF) collimators, wherein each SMF collimator comprises a single fiber core; and
a device body engaging the MCF collimator and the plurality of SMF collimators;
wherein the device body defines an interior space,
wherein the MCF collimator and the plurality of SMF collimators are arranged and/or configured to communicate within the interior space, a plurality of collimated beams, and
wherein each collimated beam is communicated between one of the plurality of SMF collimators and a corresponding one of the plurality of cores in the MCF collimator.

2. The FIFO optical device of claim 1, wherein the device body comprises an external optical tube.

3. The FIFO optical device of claim 2, wherein the device body further comprises an internal optical tube that holds at least a portion of the MCF collimator.

4. The FIFO optical device of claim 3, wherein at least a portion of the internal optical tube is disposed within the external optical tube.

5. The FIFO optical device of claim 4, wherein the internal optical tube is securely bonded or attached to the external optical tube.

6. The FIFO optical device of claim 1, further comprising an isolator core configured to apply an isolation function to the plurality of collimated beams.

7. The FIFO optical device of claim 6, wherein the isolator core is disposed at an output end of the MCF collimator.

8. The FIFO optical device of claim 1, further comprising one or more optical beam control components configured for controlling the plurality of collimated beams within the FIFO optical device.

9. The FIFO optical device of claim 8, wherein the one or more optical beam control components comprise one or more beam spacing components.

10. The FIFO optical device of claim 9, wherein the one or more beam spacing components comprise one or more glass wedge prisms.

11. The FIFO optical device of claim 8, wherein the one or more optical beam control components comprise one or more beam shortening components.

12. The FIFO optical device of claim 11, wherein the one or more beam shortening components comprise glass wedge plates.

13. The FIFO optical device of claim 1, wherein the MCF collimator is a 2-core MCF collimator, and wherein the plurality of SMF collimators comprises two SMF collimators.

14. The FIFO optical device of claim 1, wherein the MCF collimator is a 4-core MCF collimator, and wherein the plurality of SMF collimators comprises four SMF collimators.

15. The FIFO optical device of claim 1, wherein each of the MCF collimator and the plurality of SMF collimators comprises a fiber, an outer tube, a capillary, and an optical output element.

16. The FIFO optical device of claim 1, wherein the optical output element comprises a lens.

17. The FIFO optical device of claim 1, wherein the MCF collimator and the plurality of SMF collimators are arranged and/or configured to meet predefined performance criteria, the performance criteria comprising at least insertion loss.

18. The FIFO optical device of claim 17, wherein the MCF collimator and the plurality of SMF collimators are arranged and/or configured to optimize alignment of the plurality of SMF collimators relative to the MCF collimator, to reduce insertion loss.
